(19) United States
(12) Patent Application Publication
(10) Pub. No.: US 2024/0269019 A1
(43) Pub. Date: Aug. 15, 2024

(54) Patient Transport Apparatus With Stowable Footrest

(71) Applicant: Stryker Corporation, Kalamazoo, MI (US)

(72) Inventors: Shawn Trimble, Portage, MI (US); Christopher Gentile, Sturgis, MI (US)

(73) Assignee: Stryker Corporation, Kalamazoo, MI (US)

(21) Appl. No.: 18/570,358

(22) PCT Filed: Jun. 27, 2022
(86) PCT No.: PCT/US2022/035050

§ 371 Date: Dec. 14, 2023

Related U.S. Application Data
(60) Provisional application No. 63/289,210, filed on Dec. 14, 2021.

(51) Int. Cl. A61G 5/00; A61G 5/12

(52) U.S. Cl. CPC A61G 5/006; A61G 5/128

(57) ABSTRACT

A patient transport apparatus for patients. The patient transport apparatus comprises a litter including a front assembly. The patient transport apparatus further comprises a footrest assembly operatively attached to the front assembly. The footrest assembly includes a footrest deck section and a linkage assembly operatively attached to and extending between the front portion of the front assembly and the footrest assembly to guide movement of the footrest assembly relative to the front assembly between a stowed position and a deployed position.

### CROSS-REFERENCE TO RELATED APPLICATIONS

The subject patent application claims priority to, and all the benefits of, U.S. Provisional Patent Application No. 63/289,210, filed on Dec. 14, 2021, the entire contents of which are incorporated by reference herein.

### BACKGROUND

Patient support systems facilitate care of patients in a health care setting. Patient support systems comprise patient transport apparatuses such as, for example, hospital beds, stretchers, cots, tables, wheelchairs, chairs, stair chairs, and the like. Many conventional patient transport apparatuses, such as for example cots, generally include a base arranged for movement about floor surfaces, and a litter upon which a patient can be positioned or otherwise supported. Here, one or types of lift mechanisms may be employed to facilitate adjusting a vertical position of the litter relative to the base to, among other things, promote patient care, load the patient transport apparatus into an ambulance, and the like.

Conventional cots may employ one or more articulable deck sections arranged to define a patient support surface that can be adjusted to support the patient between different patient positions. For example, cots may employ an adjustable backrest or fowler deck section that can be adjusted to support the patient between a supine position, a fowler's position, and one or more other patient positions. In some cots, additional sections such a leg section, a seat section, and/or other sections may be provided to facilitate adjusting the patient support surface to other patient positions, such as a gatch position. In some types of patient transport apparatuses, such as those realized as stair chair (also referred to as “evacuation chairs”), foot rests may be employed to support a patient's feet.

While patient transport apparatuses have generally performed well for their intended purpose, there remains a need in the art for patient support surfaces that can be adjusted to support patients in a number of different patient positions to improve patient care during transport.

### SUMMARY

One general aspect of the present disclosure includes a patient support apparatus including a front assembly having a front portion and a bottom end including a wheel for contacting a ground surface. The apparatus also includes a footrest assembly operatively attached to the front assembly. The footrest assembly includes a footrest deck section extending between a first edge and a second edge, and a linkage assembly operatively attached to and extending between the front portion of the front assembly and the footrest deck section to guide movement of the footrest deck section relative to the front assembly. The footrest deck section is configured to move between a stowed position where the footrest deck section is substantially parallel to the front portion of the front assembly and the first edge is arranged further than the second edge from the wheel, and a deployed position where the footrest deck section is substantially perpendicular to the front portion of the front assembly and the first edge is arranged closer than the second edge to the wheel.

In other words, in the stowed position, the front surface of the footrest deck section is substantially parallel with and faces away from the front portion of the front assembly, and in the deployed position, the front surface is substantially perpendicular to the front portion of the front assembly and arranged such that the front surface faces away from the ground surface. In yet other words, in the stowed position, the footrest deck section is substantially parallel to the front portion of the front assembly, and in the deployed position, the footrest deck section is substantially perpendicular to the front portion of the front assembly, and the second edge of the footrest deck section follows a linear translation path defined by movement of the footrest deck section between the stowed position and the deployed position.

The linkage assembly may include a six-bar linkage. In some configurations, the linkage assembly may include a pair of hinge subassemblies each respectively including a first member and a second member. Concurrent movement of the pair of hinge subassemblies guide the footrest deck section along a linear translation path as the footrest deck section moves between the stowed position and the deployed position. The linkage assembly further may include at least one guide bar to guide motion of the footrest deck section as the footrest deck section moves between the stowed position and the deployed position. The footrest assembly further may include a biasing member arranged to urge the guide bar such that the footrest deck section is biased toward the stowed position.

The footrest assembly further may include a toggle member operable between an engaged state where the toggle member engages the guide bar to limit movement of the footrest deck section relative to the front assembly, and a disengaged state where the toggle member is spaced from the guide bar to permit movement of the footrest deck section relative to the front assembly. The footrest assembly further may include a release lever operatively attached to the toggle member and arranged for selective movement between a first state where the toggle member is in the engaged state, and a second state where the release lever moves the toggle member to the disengaged state to enable movement of the footrest deck section relative to the front assembly. The footrest biasing member urges the footrest deck section toward the stowed position in response to movement of the release lever to the second state to automatically retract the footrest deck section to the stowed position.

### BRIEF DESCRIPTION OF THE DRAWINGS

Advantages of the present disclosure will be readily appreciated as the same becomes better understood by reference to the following detailed description when considered in connection with the accompanying drawings.

FIG. 1A is a perspective view of a patient transport apparatus of a patient support system of the present disclosure, shown with the patient transport apparatus operating in an undocked mode with a base having stabilizers arranged in a deployed configuration to brace the base against floor surfaces for loading a litter, the litter shown positioned adjacent to the base and arranged in a chair configuration.

FIG. 1B is another perspective view of the patient transport apparatus of FIG. 1A, shown with the patient transport apparatus operating in a docked mode with the litter secured to the base and with the stabilizers arranged in a retracted configuration.

FIG. 2 is a schematic view of a control system of the patient transport apparatus of FIGS. 1A-1B.

FIG. 3A is a front perspective view of the litter of the patient transport apparatus.

FIG. 3B is a rear perspective view of the litter of the patient transport apparatus.

FIG. 4A is a partial front perspective view of the litter of the patient transport apparatus including a footrest deck section in a stowed position.

FIG. 4B is a partial front perspective view of the litter of the patient transport apparatus including the footrest deck section in an intermediate position.

FIG. 4C is a partial front perspective view of the litter of the patient transport apparatus including the footrest deck section in a deployed position.

FIG. 5 is a partial front perspective view of a linkage assembly of the patient transport apparatus.

FIG. 6A is a partial front perspective view of the litter of the patient transport apparatus including the linkage assembly and the footrest deck section in the stowed position.

FIG. 6B is a partial front perspective view of the litter of the patient transport apparatus including the linkage assembly and the footrest deck section in the intermediate position.

FIG. 6C is another partial front perspective view of the litter of the patient transport apparatus including the linkage assembly and the footrest deck section in the deployed position.

FIG. 7A is a partial bottom perspective view of the litter of the patient transport apparatus including the linkage assembly and the footrest deck section in the deployed position.

FIG. 7B is a partial bottom perspective view of the litter of the patient transport apparatus including the linkage assembly and the footrest deck section in the intermediate position.

FIGS. 8A-8E show partial side perspective views of the litter of the patient transport apparatus in a sequence of a toggle member moving from an engaged to a disengaged state and the footrest deck section retracting from the deployed position to the stowed position.

FIGS. 9A-9E show partial side views of the litter of the patient transport apparatus in a sequence of a toggle member moving from an engaged to a disengaged state and the footrest deck section retracting from the deployed position to the stowed position.

### DETAILED DESCRIPTION

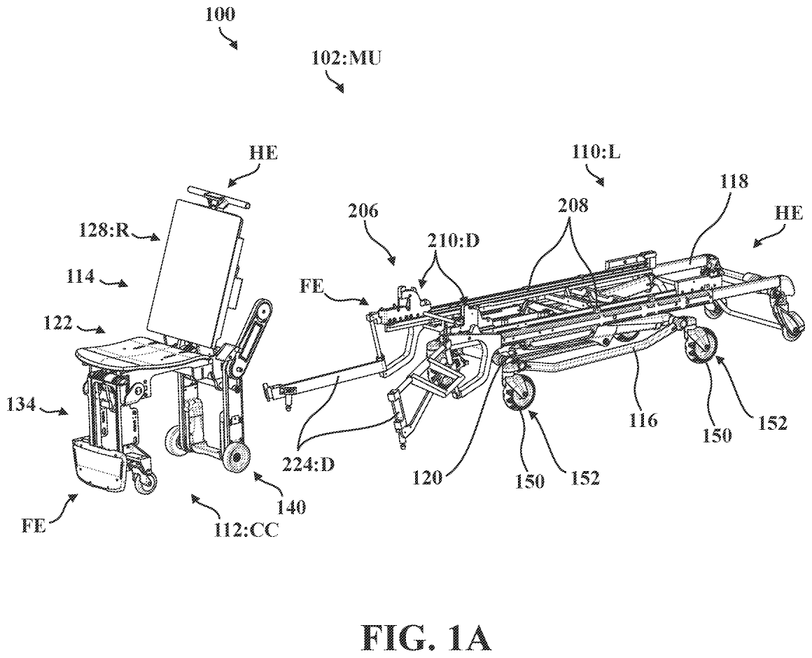

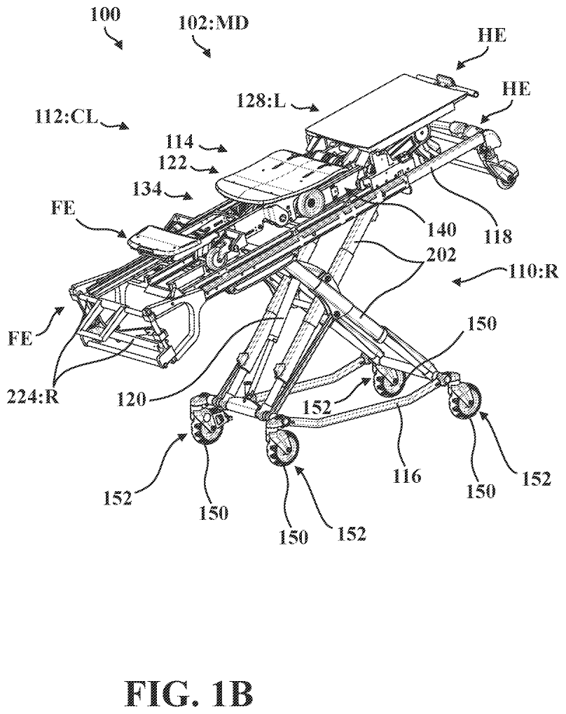

Referring to FIGS. 1A-1B, portions of a patient support system 100 are shown including a patient transport apparatus 102 for supporting a patient in a health care setting according to aspects of the present disclosure. As will be appreciated from the subsequent description below, while the illustrated versions of the patient transport apparatus 102 described herein are configured as adjustable cots and stair chairs for transporting patients, the patient transport apparatus 102 may comprise a hospital bed, a stretcher, a table, a wheelchair, a chair, or a similar apparatus utilized in the care of a patient. The version of the patient transport apparatus 102 shown in FIGS. 1A-1B generally comprises a base 110 and a litter 112. The litter 112 defines or otherwise comprises a patient support surface 114 to support a patient.

In some versions, the patient transport apparatus 102 may comprise a reconfigurable patient support as described in U.S. Pat. No. 9,486,373, which is hereby incorporated by reference in its entirety. In some versions, the patient transport apparatus 102 may comprise a reconfigurable transport apparatus as described in U.S. Pat. No. 9,510,981, which is hereby incorporated by reference in its entirety. In some versions, the patient transport apparatus 102 may comprise a person support apparatus system as described in U.S. Patent Application Publication No. 2018/0028383, which is hereby incorporated by reference in its entirety. In some versions, the patient transport apparatus 102 may comprise a patient transfer apparatus with integrated tracks as described in U.S. patent application Ser. No. 15/854,943, which is hereby incorporated by reference in its entirety. In some versions, the patient transport apparatus 102 may comprise a variable speed patient transfer apparatus as described in U.S. patent application Ser. No. 15/854,199, which is hereby incorporated by reference in its entirety. In some versions, the patient transport apparatus 102 may comprise a patient transfer apparatus as described in U.S. patent application Ser. No. 15/855,161, which is hereby incorporated by reference in its entirety. In some versions, the patient transport apparatus 102 may comprise an ambulance cot as described in U.S. Pat. No. 7,398,571, which is hereby incorporated by reference in its entirety.

With continued reference to FIGS. 1A-1B, the base 110 and litter 112 each have a head end HE and a foot end FE corresponding to designated placement of the patient's head and feet on the patient transport apparatus 102. In FIG. 1A, the litter 112 is shown separated from the base 110; as is described in greater detail below, the base 110 is configured to removably receive and support the litter 112 in certain situations. Put differently, in the illustrated version, the litter 112 is configured for releasable attachment to the base 110. The base 110 generally includes a base frame 116, an intermediate frame 118, and a base lift device 120. The intermediate frame 118 is spaced above the base frame 116 and is moved relative to the base frame 116 via the base lift device 120 as described in greater detail below. Although not illustrated in detail in the drawings, a mattress (or sections thereof) may be disposed on or integral with the litter 112. In such circumstances, the mattress comprises or otherwise defines a secondary patient support surface 114 upon which the patient is supported.

In the illustrated versions, the litter 112 employs a plurality of assemblies, some of which are capable of being articulated relative to others in various ways and under certain operating conditions to adjust the patient support surface 114 and to facilitate docking to and undocking from the base 110. In the illustrated version, the litter 112 generally includes a seat assembly 122 with a seat frame 124 and a seat section 126, a fowler assembly 128 with a fowler frame 130 and a fowler section 132, a front assembly 134 with a front frame 136 and a front section 138, a rear assembly 140 with a rear frame 142. Each of the assemblies 122, 128, 134, 140 introduced above will be described in greater detail below.

In the illustrated versions, the fowler assembly 128 pivots relative to the seat assembly 122 about a fowler axis XW, the front assembly 134 pivots relative to the seat assembly 122 about a front axis XF, and the rear assembly 140 pivots relative to the seat assembly 122 about a rear axis XR. In the illustrated version, the seat section 126, the fowler section 132, and the front section 138 each provide support to the patient and, thus, generally cooperate to define the patient support surface 114. In some configurations, the front section 138 may also be configured to translate along the front frame 136, such as is described in U.S. patent application Ser. No. 16/705,878, the disclosure of which is hereby incorporated by reference in its entirety. It will be appreciated that the fowler section 132 and the front section 138 may pivot relative to the seat section 126, or may articulate relative to the seat section 126 in any manner. For instance, the fowler section 132 and/or the front section 138 may both pivot and translate relative to the seat section 126 in some configurations.

Caregiver interfaces 148, such as handles, help facilitate movement of the patient transport apparatus 102 over floor surfaces. Here, caregiver interfaces 148 may be coupled to the fowler assembly 128, the front assembly 134 (not shown), the intermediate frame 118, and the like. Additional caregiver interfaces 148 may be integrated into other components of the patient transport apparatus 102. The caregiver interfaces 148 are graspable by the caregiver to manipulate the patient transport apparatus 102 for movement.

Base wheels 150 are coupled to the base frame 116 to facilitate transport over floor surfaces. The base wheels 150 are arranged in each of four quadrants of the base 110 adjacent to corners of the base frame 116. In the illustrated versions, the base wheels 150 are caster wheels, which are able to rotate and swivel relative to the base frame 116 during transport. Each of the base wheels 150 forms part of a base caster assembly 152. Each base caster assembly 152 is mounted to the base frame 116. It should be understood that various configurations of base caster assemblies 152 are contemplated. In addition, in some configurations, the base wheels 150 are not caster wheels and may be non-steerable, steerable, non-powered, powered, or combinations thereof. Additional base wheels 150 are also contemplated. For example, the patient transport apparatus 102 may comprise four non-powered, non-steerable wheels, along with one or more powered wheels. In some cases, the patient transport apparatus 102 may not include any wheels. In other configurations, one or more auxiliary wheels (powered or non-powered), which are movable between stowed positions and deployed positions, may be coupled to the base frame 116. In some cases, when these auxiliary wheels are located between caster assemblies and contact the floor surface FS in the deployed position, they cause two of the base caster assemblies 152 to be lifted off the floor surface thereby shortening a wheel base of the patient transport apparatus 102. A fifth wheel may also be arranged substantially in a center of the base 110. Other configurations are contemplated.

It should be noted that in many of the drawings described herein, certain components of the patient transport apparatus 102 have been omitted from view for convenience of description and ease of illustration.

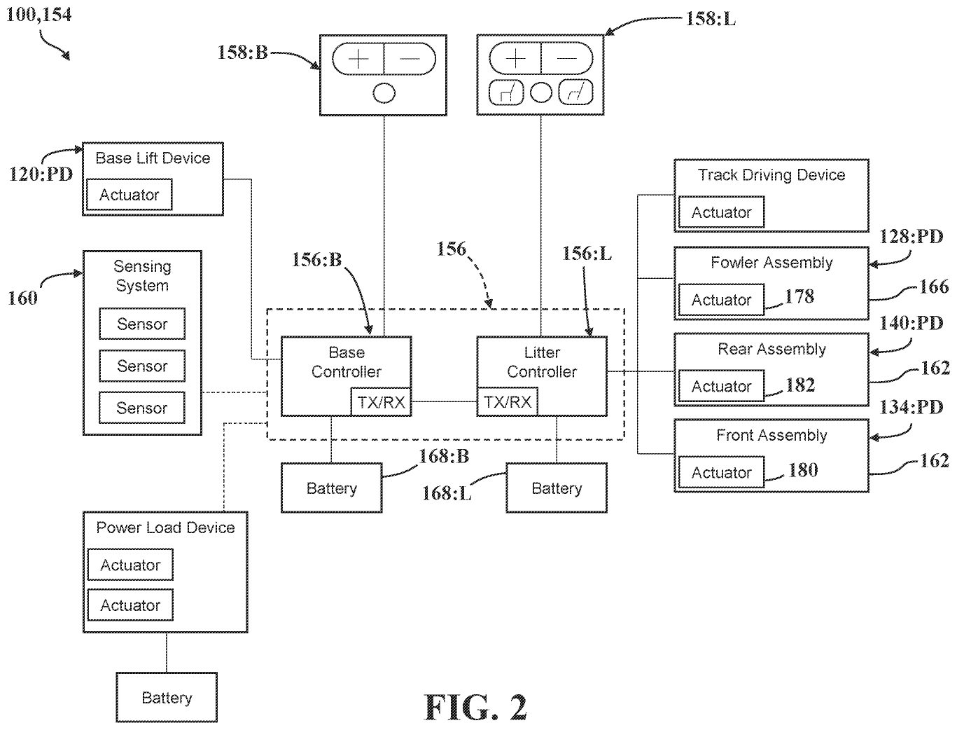

Referring now to FIG. 2, a control system 154 of the patient transport apparatus 102 is shown schematically. The control system 154 generally comprises one or more powered devices PD operated by a base controller 156B and/or a litter controller 156L (collectively referred to herein as “controller 156”) in response to actuation of a base user interface 158B and/or a litter user interface 158L (collectively referred to herein as “user interface 158”) in response to state signals received from a sensing system 160. Each of these components will be described in greater detail below.

With continued reference to FIG. 2, each of the one or more powered devices PD of the control system 154 is configured to perform one or more predetermined functions. To this end, the powered devices PD employ one or more components that utilize electricity in order to perform functions. One or more powered devices PD of the patient support system 100 and/or the patient transport apparatus 102 may comprise powered adjustment devices, such as a power load device for loading the patient transport apparatus 102 into a cargo area of an ambulance (not shown), the base lift device 120, a litter lift device 162, and a fowler section adjustment device 166. To this end, in some versions, the base 110 employs a base energy storage device 168B and the litter 112 employs a litter energy storage device 168L (collectively referred to herein as “energy storage device 168”). Other powered devices PD are also contemplated.

The powered devices PD may have many possible configurations for performing the predetermined functions of the patient transport apparatus 102. As will be appreciated from the subsequent description below, powered devices PD may cooperate with or otherwise form a part of the patient transport apparatus 102 in certain versions. Exemplary configurations of some of the powered devices PD are described in greater detail below. One or more actuators may be used to effectuate functions of each powered device PD. It should be understood that numerous configurations of the powered devices PD, other than those specifically described herein, are contemplated. Exemplary scenarios of how certain powered devices PD may be utilized are also described below. However, numerous other scenarios not described herein are also contemplated.

The litter 112 of the present disclosure is configured to be removably attached to the intermediate frame 118 of the base 110, as noted above and as is described in greater detail below, and is generally operable between: an undocked mode MU (see FIG. 1A) where the litter 112 supports the patient for movement independent of the base 110, and a docked mode MD (see FIG. 1B) where the litter 112 support the patient for movement concurrent with the base 110. The process of moving between the undocked mode MU and the docked mode MD is described in U.S. Provisional Patent Application No. 63/237,304, entitled “Patient Transport Apparatus Base with Trolley for Docking Removable Litter”, filed on Aug. 26, 2021, which is hereby incorporated herein by reference.

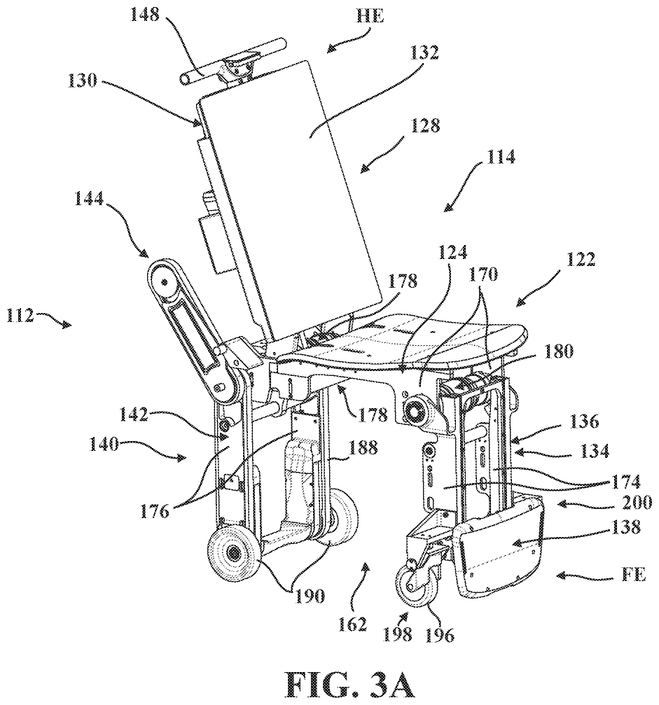

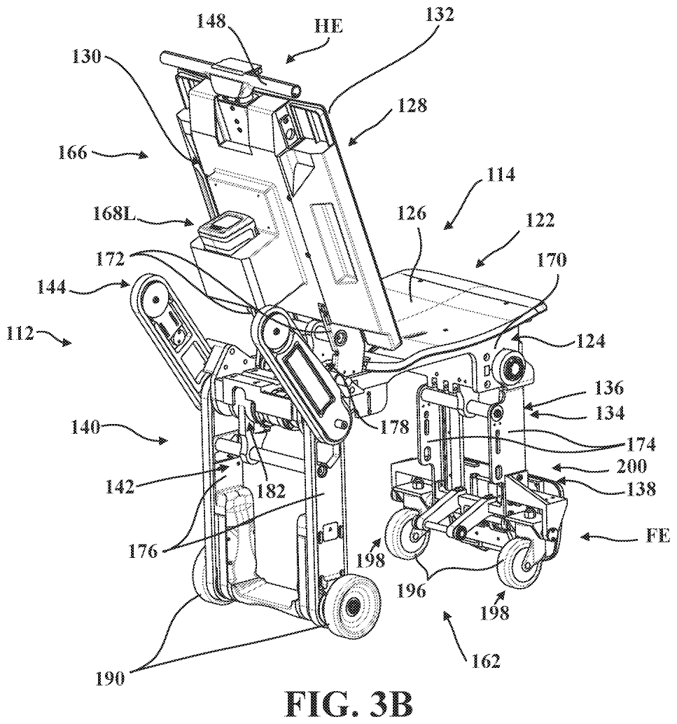

In the version shown in FIGS. 3A-3B, when operating in the chair configuration CC, the litter 112 is configured to serve as a mobile chair to transport the patient along floor surfaces FS. Mobile chairs (sometimes called “stair chairs”) are used to evacuate patients from buildings where patient accessibility is limited, such as buildings having more than one floor. As noted above, the patient support surface 114 of the litter 112 of the illustrated patient transport apparatus 102 is generally defined by the fowler section 132, the seat section 126, and the front section 138. Here, the seat section 126 is supported by the seat frame 124, and the fowler section 132 is supported by the fowler frame 130 that is coupled to the seat frame 124 such that the fowler frame 130 may pivot or otherwise articulate relative to the seat frame 124. The front section 138 is supported by the front frame 136 which is coupled to the seat frame 124 such that the front frame 136 may pivot or otherwise articulate relative to the seat frame 124. Here too, the rear assembly 140 is coupled to the seat frame 124 such that the rear frame 142 may pivot or otherwise articulate relative to the seat frame 124.

In some configurations, the seat frame 124 may include seat frame members 170 spaced laterally apart from and fixed relative to each other. Similarly, the fowler frame 130 may include fowler frame members 172 spaced laterally apart and fixed relative to each other. The front frame 136 may include front legs 174 spaced laterally apart and fixed relative to each other, and the rear frame 142 may include rear legs 176 spaced laterally apart and fixed relative to each other. In the illustrated version, the litter 112 comprises a fowler actuator 178, a front actuator 180, and a rear actuator 182 which are each driven by the controller 156 (e.g., by the litter controller 156L) and are operatively attached to the seat assembly 122 to facilitate respectively pivoting or otherwise articulating the fowler assembly 128, the front assembly 134, and the rear assembly 140 relative to the seat assembly 122.

In the illustrated versions, the fowler assembly 128 is movable via the fowler actuator 178 between a fowler raised position 128R (see FIGS. 1A), a fowler lowered position 128L (see FIG. 1B), and one or more intermediate fowler positions between the fowler raised position 128R and the fowler lowered position 128L.

The rear assembly 140 also includes rear wheels 190 rotatably coupled to the rear legs 176 that are configured to be disposed in contact with the floor surface FS, such as to support the litter 112 for movement in the chair configuration CC. In the illustrated versions, the rear wheels 190 are freely rotatable. In alternative versions, the rear wheels 190 may be powered drive wheels coupled to the controller 156. Other configurations are contemplated. As described in U.S. Provisional Patent Application No. 63/237,301, entitled “Patient Transport Apparatus with Base Stabilizers for Loading and Unloading Removable Litters”, filed on Aug. 26, 2021 and U.S. Provisional Patent Application No. 63/237,304, entitled “Patient Transport Apparatus Base with Trolley for Docking Removable Litter”, filed on Aug. 26, 2021, which are hereby incorporated herein by reference in their entirety, the rear assembly 140 is movable via the rear actuator 182 between a rear assembly loft position 140L, a rear assembly chair position 140C, a rear assembly stair position 140S, a rear assembly dock position 140D, and one or more intermediate rear assembly positions 1401 between the rear assembly loft position 140L and the rear assembly dock position 140D.

In some configurations, the rear assembly 140 may also include a ski assembly 144, as described in U.S. Provisional Patent Application No. 63/237,307, entitled “Patient Transport Apparatus with Ski Assemblies”, filed on Aug. 26, 2021, which is hereby incorporated herein by reference in its entirety.

The front legs 174 of the front assembly 134 support respective front wheels 196 at a bottom end of the front assembly 134, which are realized as part of respective front caster assemblies 198 arranged to facilitate movement of the litter 112 in the chair configuration CC. In the illustrated versions, the front wheels 196 are freely rotatable, but could be motorized, braked, and the like in some versions. As noted above, in some versions, the front section 138 may be translatable along the front frame 136, such as when the litter 112 moves between the loft configuration CL and the chair configuration CC, and/or when the litter 112 operates in the docked mode MD. To this end, the front assembly 134 may include an extension mechanism, generally indicated at 200, configured to longitudinally position the front section 138 relative to the front legs 174. While not depicted in detail herein, the extension mechanism 200 may be similar to as is described in U.S. patent application Ser. No. 16/705,878, the disclosure of which is incorporated by reference in its entirety. As described in U.S. Provisional Patent Application No. 63/237,301, entitled “Patient Transport Apparatus with Base Stabilizers for Loading and Unloading Removable Litters”, filed on Aug. 26, 2021 and U.S. Provisional Patent Application No. 63/237,304, entitled “Patient Transport Apparatus Base with Trolley for Docking Removable Litter”, filed on Aug. 26, 2021, which are hereby incorporated herein by reference in their entirety, the front assembly 134 is movable via the front actuator 180 between a front assembly loft position 134L, a front assembly chair position 134C, a front assembly stair position 134S, and one or more intermediate front assembly positions 1341 between the front assembly loft position 134L and the front assembly dock position 134D.

The litter lift device 162 is coupled to the litter 112 and is configured to raise and lower the patient between minimum and maximum heights of the litter 112, and to generally facilitate movement between the loft configuration CL, the chair configuration CC, and the stair configuration CS when the litter 112 is separated from the base 110. To this end, the illustrated litter lift device 162 generally includes the front actuator 180 and the rear actuator 182. The base lift device 120 is coupled to the base 110 and is configured to raise and lower the patient between a plurality of vertical configurations including a maximum raised configuration 110R (see FIG. 1B), a maximum lowered configuration 110L (see FIG. 1A), and a plurality of vertical configurations therebetween, both while the litter 112 is supported by the base 110 and, in some versions, while the litter 112 is undocked from the base 110.

In the representative version illustrated in FIGS. 1A-1B, the base 110 comprises one or more lift arms 202 coupling the intermediate frame 118 to the base frame 116. The base lift device 120 comprises one or more base lift actuators f coupled to at least one of the base frame 116 and the intermediate frame 118 to raise and lower the intermediate frame 118 and litter 112 relative to the floor surface FS and the base frame 116. The base lift device 120 may be configured to operate in the same manner or a similar manner as the lift mechanisms shown in U.S. Pat. Nos. 7,398,571, 9,486,373, 9,510,981, and/or U.S. Patent Application Publication No. 2018/0028383, previously referenced.

The base 110 of the patient transport apparatus 102 also generally includes a docking subassembly 206 operatively coupled to the intermediate frame 118 as described in U.S. Provisional Patent Application No. 63/237,304, entitled “Patient Transport Apparatus Base with Trolley for Docking Removable Litter”, filed on Aug. 26, 2021, which is hereby incorporated herein by reference in its entirety.

In the illustrated version, the base 110 also includes a stabilizer 224 operatively attached to the foot end FE of the intermediate frame 118 and configured for movement between a retracted configuration 224R (see FIG. 1B) where the stabilizer 224 is disposed in spaced relation from the floor surface FS, and a deployed configuration 224D (see FIG. 1A) where the stabilizer 224 engages the floor surface to brace the base 110 at an additional point of contact with the floor surface FS to stabilize the base 110, as described in U.S. Provisional Patent Application No. 63/237,301, entitled “Patient Transport Apparatus with Base Stabilizers for Loading and Unloading Removable Litters”, filed on Aug. 26, 2021, which is hereby incorporated herein by reference in its entirety.

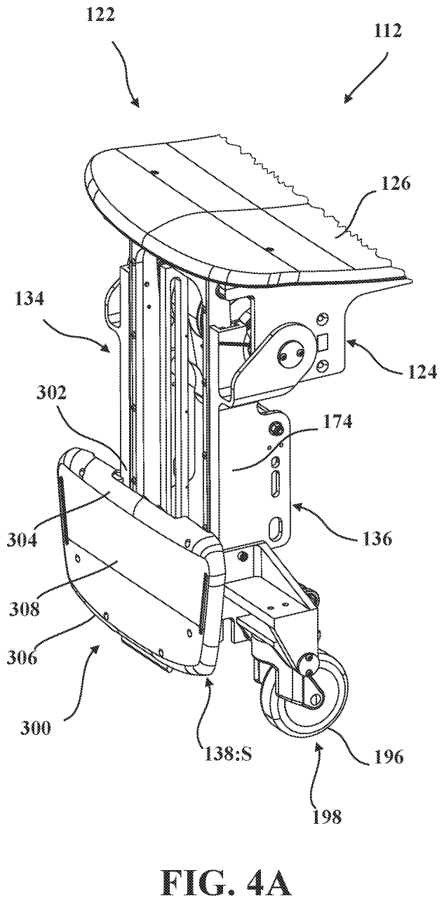

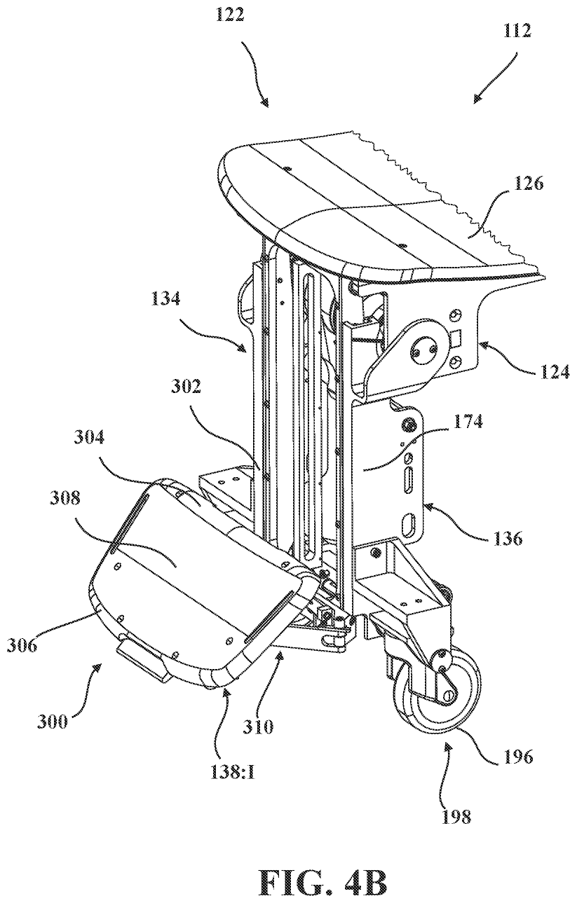

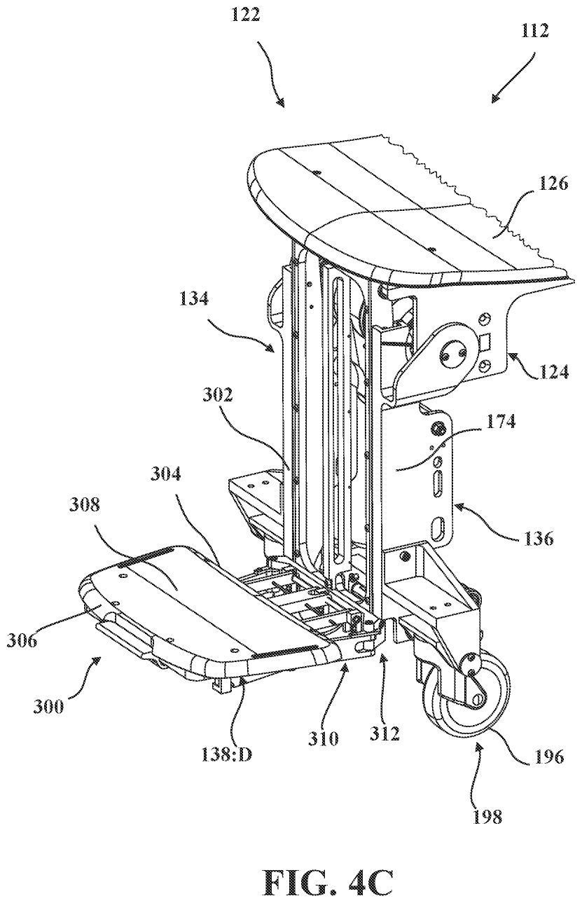

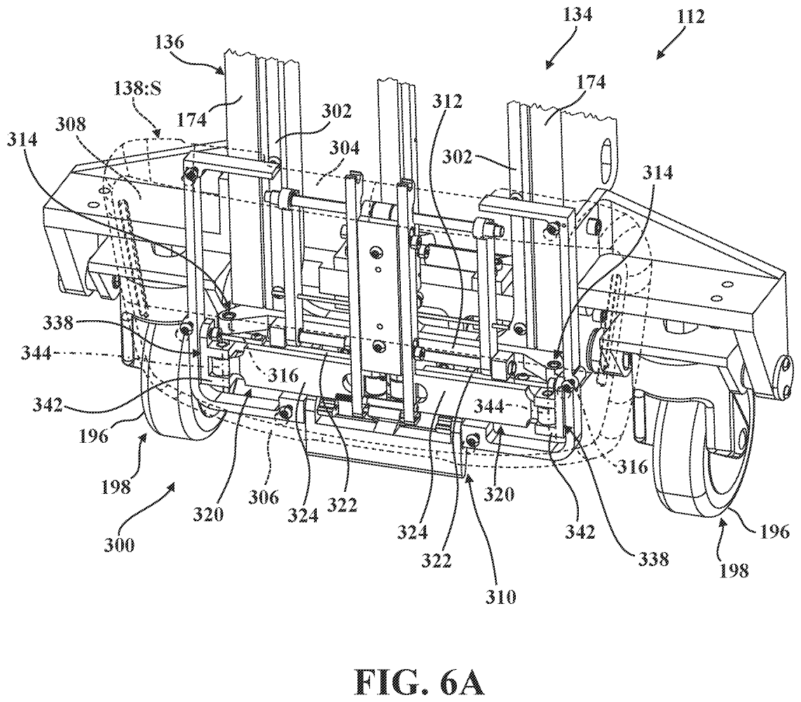

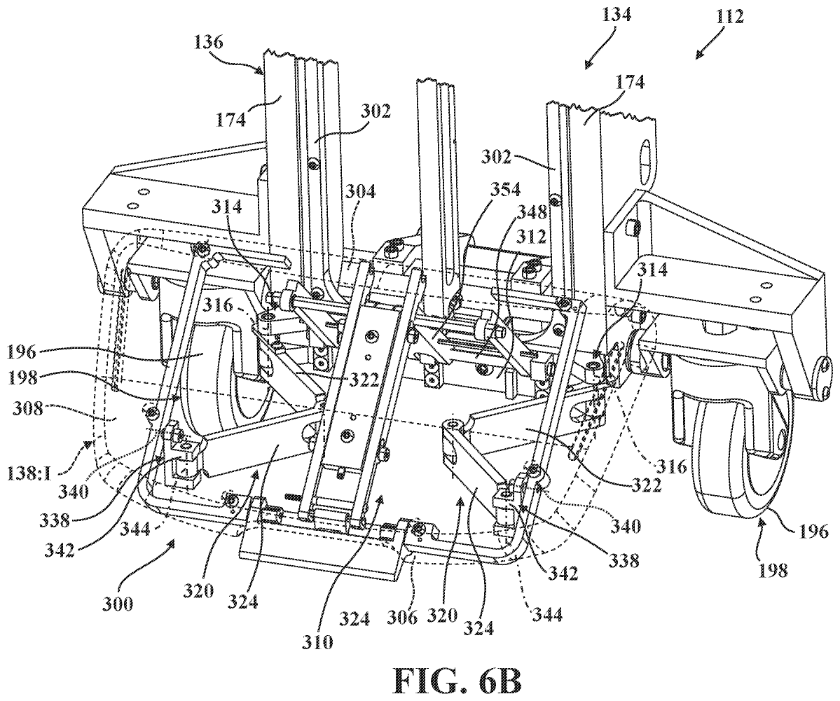

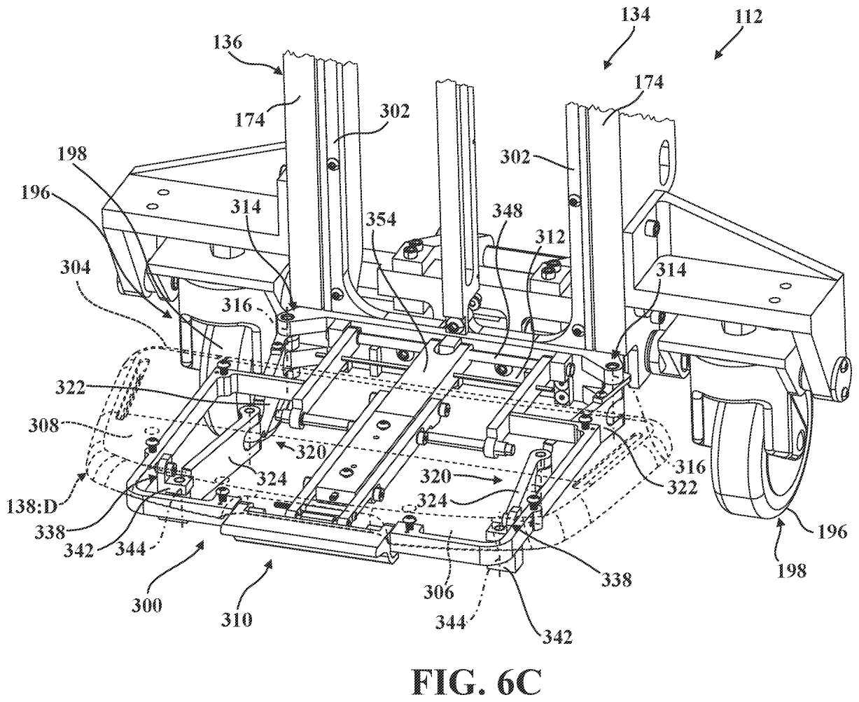

Referring now to FIGS. 4A-9E, the patient support apparatus 102 further includes a footrest assembly 300. The footrest assembly 300 extends from a front portion 302 of the front assembly 134. The footrest assembly 300 includes the front section 138 (also referred to hereafter as footrest deck section 138). The footrest deck section 138 extends between a first edge 304 and a second edge 306 and defines a front surface 308 for supporting a patient's feet or legs. The footrest assembly 300 further includes a linkage assembly 310. The linkage assembly 310 is operatively attached to and extends between the front portion 302 of the front assembly 134 and the footrest deck section 138 to guide movement of the footrest deck section 138 relative to the front assembly 134. Particularly, the linkage assembly 310 moves the footrest deck section 138 between a stowed position 138S (shown in FIGS. 4A and 6A) and a deployed position 138D (shown in FIGS. 4C and 6C).

Referring to FIGS. 4A and 6A, in the stowed position 138S, the footrest deck section 138 is substantially parallel to the front portion 302 of the front assembly 134 and the first edge 304 is arranged further than the second edge 306 from the wheel 196. In other words, in the stowed position 138S, the front surface 308 of the footrest deck section 138 is substantially parallel with and faces away from the front portion 302 of the front assembly 134. Accordingly referring to FIG. 1B, the footrest deck assembly may define a portion of the patient support surface 114 for supporting a patient's legs, such as when the litter 112 is in the loft configuration CL.

Referring to FIGS. 4B and 6B, the footrest assembly 300 is shown with the footrest deck section 138 in an intermediate position 1381. Notably, as the footrest deck section 138 moves between the stowed position 138S and the deployed position 138D, the second edge 306 of the footrest deck section follows a substantially linear translation path. In other words, instead of the footrest deck section 138 flipping down from the stowed position 138S to the deployed position 138D, the linkage assembly 310 guides movement of the footrest deck section 138 such that the second edge 306 translates away from the front portion 302 and the first edge translates downward and remains substantially adjacent to the front portion 302.

Referring to FIGS. 4C and 6C, in the deployed position 138D the footrest deck section 138 is substantially perpendicular to the front portion 302 of the front assembly 134 and the first edge 304 is arranged closer than the second edge 306 to the wheel 196. In other words, the front surface 308 is substantially perpendicular to the front portion 302 of the front assembly 134 and arranged such that the front surface 308 faces away from a ground surface, such as the floor surface FS. Accordingly, the footrest deck section 138 may define a portion of the patient support surface 114 for supporting a patient's feet, such as when the litter 112 is in the chair configuration CC. Additionally, when in the deployed position 138D, the footrest deck section 138 is spaced from the front assembly 134. The footrest deck section 138 may be spaced from the front assembly 134 at a distance defined by a ratio of the height of the footrest deck section 138. For example, the distance may be 0.01 of the height, 0.05 of the height, 0.1 of the height, 0.2 of the height, 0.33 of the height, 0.5 of the height, or even 1:1 of the height, or more.

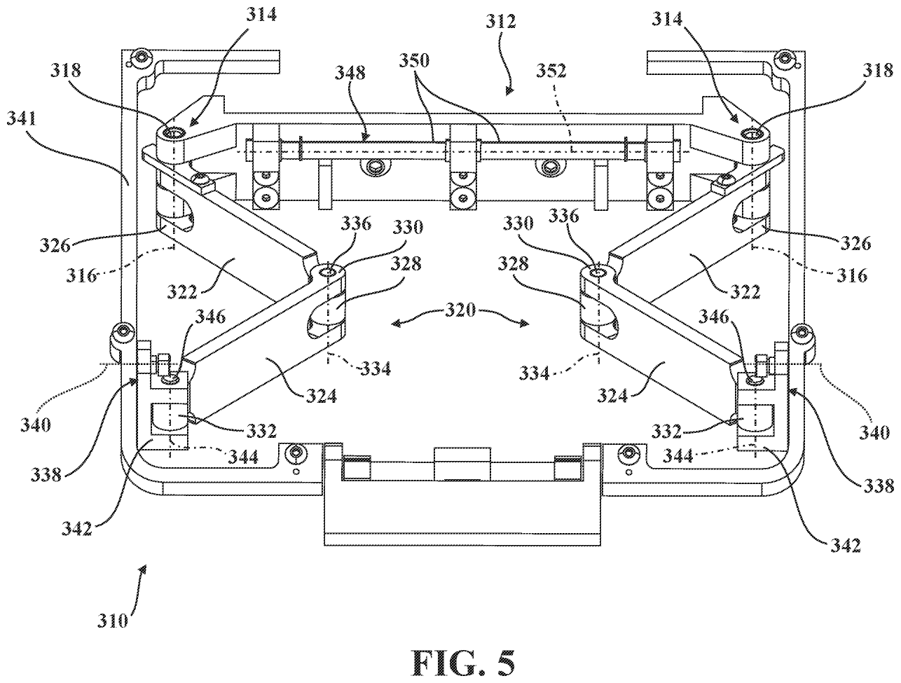

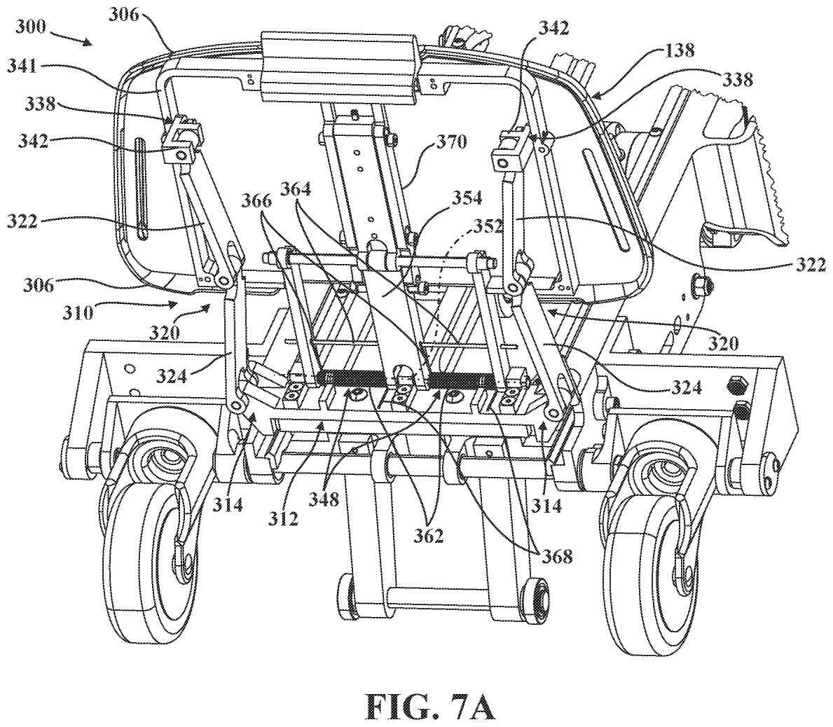

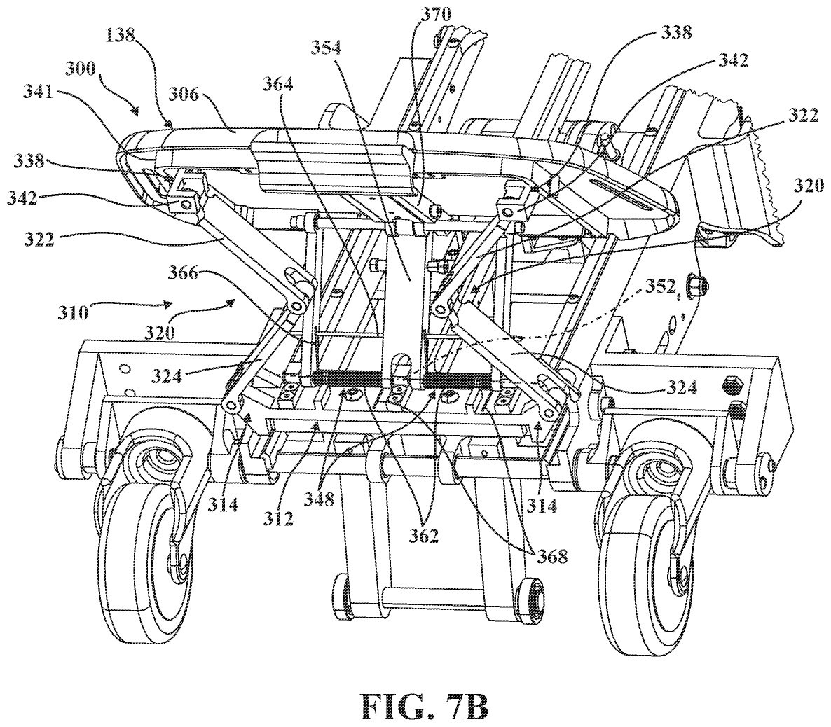

Referring now to FIGS. 5 and 7A-7B, the footrest assembly 300 may further comprise a linkage mounting member 312. The linkage mounting member 312 may be operatively attached to the front assembly 134, such as being coupled to the front portion 302. Accordingly, the linkage mounting member 312 may be interposed between the linkage assembly 310 and the front portion 302 of the front assembly 134. As a result, the linkage assembly 310 may be operatively attached to and extend between the footrest deck section 138 and the linkage mounting member 312.

Referring to FIG. 5, the linkage mounting member 312 may include a pair of vertical pivot mounts 314. The pair of vertical pivot mounts 314 each extend from the linkage mounting member 312 and each define a respective vertical mount pivot axis 316. For example, the pair of vertical pivot mounts may each be configured to receive respective vertical pivot dowels 318 each defining one of the vertical mount pivot axes 316. As will be described in further detail below, the vertical pivot mounts 314 provide an interface for the linkage assembly 310 to couple to the linkage mounting member 312.

The linkage assembly 310 generally includes an arrangement of components to effectuate movement of the footrest deck section 138 between the stowed position 138S and the deployed position 138D, and may be realized in various ways, such as via a six-bar linkage. Other configurations are contemplated. Referring to FIGS. 5-7B, in some configurations, the linkage assembly 310 may include a pair of hinge subassemblies 320. Each pair of hinge subassemblies 320 may include a first member 322 and a second member 324. As shown in FIG. 5, the first member 322 may extend between a first hinge end 326 and a first mounting end 328. The first mounting end 328 of the first member 322 of each of the pair of hinge subassemblies 320 may be coupled to a respective one of the pair of vertical pivot mounts 314 (for example, using respective vertical pivot dowels 318). Accordingly, the first member 322 of each of the pair of hinge subassemblies 320 is capable of pivoting movement about the vertical mount pivot axis 316.

With continued reference to FIG. 5, the second member 324 may extend between a second hinge end 330 and a second mounting end 332. The second hinge end 330 of each second member 324 may be coupled to a respective first hinge end 326 of the first member 322 of each of the pair of hinge subassemblies 320. Accordingly, a pair of the first member 322 and second member 324 are respectively coupled to each other for pivoting movement relative to each other about a hinge pivot axis 334. In some configurations, the first hinge end 326 and the second hinge end 330 are coupled using a hinge pivot dowel 336 that defines the hinge pivot axis 334. However, it is contemplated that other arrangements for pivotably coupling the first hinge end 326 and the second hinge end 330 may be used. In some configurations, the hinge pivot axis 334 is parallel to the vertical mount pivot axis 316 such that the first member 322 and second member 324 maintain a consistent angular relationship with the linkage mounting member 312 in a vertical direction. Additionally, the second mounting end 332 may be operatively attached to the footrest deck section 138. As is depicted sequentially in FIGS. 6A-6C, concurrent movement of the pair of hinge subassemblies 320 guides movement of the second edge footrest deck section 138 between the stowed position 138S and the deployed position 138D along a substantially linear translation path.

Referring to FIGS. 5 and 6A-6C, the linkage assembly 310 may further include a pair of footrest mounting members 338. Each of the footrest mounting members 338 may be coupled to opposing lateral regions of the footrest deck section 138 for pivoting movement about a footrest mounting axis 340. For example, the footrest deck section 138 may include a footrest deck frame 341 (see FIG. 5) having members coupled to opposing lateral sides of the footrest deck section 138 and configured to couple to the footrest mounting members 338. The footrest mounting axis 340 is disposed on non-parallel relation to the vertical mount pivot axes 316. For example, in the configuration shown in FIGS. 5 and 6A-6C, the footrest mounting axis 340 is disposed orthogonal to the vertical mount pivot axes 316.

Additionally, the pair of footrest mounting members 338 each define a hinge mounting member 342. Each of the hinge mounting members 342 are coupled to a respective one of the second mounting ends 332 of each second member 324. Accordingly, each second member 324 is coupled to one of the hinge mounting members 342 for pivoting movement about a hinge mounting axis 344. The hinge mounting axis 344 may be disposed in a parallel relation to each of the hinge pivot axes 334 and/or the vertical mount pivot axes 316. In some configurations, the hinge mounting members 342 are coupled to the second mounting ends 332 using a mount pivot dowel 346 that defines the hinge mounting axis 344. However, it is contemplated that any suitable mechanism for pivotably coupling the second members 324 and the hinge mounting members 342. Referring to the sequence of FIG. 5

As shown in FIGS. 6A-6C, the footrest mounting members 338 pivot relative to the footrest deck section 138 as the footrest deck section 138 moves between the stowed position 138S and the deployed position 138D such that the hinge mounting members 342 remain parallel with the hinge pivot axes 334 and/or the vertical mount pivot axes 316. For example, referring first to FIG. 6A, when the footrest deck section 138 is in the stowed position 138S, the footrest mounting members 338 are substantially parallel to the footrest deck section 138. Referring next to FIG. 6B, as the footrest deck section 138 moves from the stowed position 138S into the intermediate position 1381, the footrest mounting members 338 pivot relative to the footrest deck section 138 such that the hinge mounting members 342 remain substantially parallel with the hinge pivot axes 334 and/or the vertical mount pivot axes 316. Further, referring to FIG. 6C, when the footrest deck section 138 is in the deployed position 138D, the footrest mounting members 338 are substantially perpendicular to the footrest deck section 138 such that 138 such that the hinge mounting members 342 remain substantially parallel with the hinge pivot axes 334 and/or the vertical mount pivot axes 316.

Referring to FIGS. 5 and 7A-7B, the linkage mounting member 312 may further comprise a horizontal pivot mount 348 extending from the linkage mounting member 312. The horizontal pivot mount 348 may include a horizontal pivot dowel 350 defining a horizontal pivot axis 352. However, other configurations are contemplated.

With reference to FIGS. 6A-9E, the linkage assembly 310 may further include at least one guide bar 354. The at least one guide bar 354 extends between a guide bar mounting end 356 and a guide bar pivot end 358. The guide bar mounting end 356 may be coupled to the horizontal pivot mount 348 for pivoting movement of the at least one guide bar 354 relative to the horizontal pivot mount 348. The guide bar pivot end 358 may be coupled to a guide bar pivot mount 360 arranged on the footrest deck section 138 for pivoting movement of the at least one guide bar 354 relative to the guide bar pivot mount 360. Accordingly, the at least one guide bar 354 guides motion of the first edge 304 of the footrest deck section 138 as the footrest deck section 138 moves between the stowed position 138S and the deployed position 138D.

As shown in FIGS. 7A-7B, the footrest assembly 300 may further comprise a biasing member 362. The biasing member 362 may be arranged to urge the at least one guide bar 354 such that the footrest deck section 138 is biased toward the stowed position 138S. For example, the biasing member 362 may be a torsion spring disposed about the horizontal pivot mount 348 and operatively attached to the at least one guide bar 354 and the linkage mounting member 312. In some configurations, the footrest assembly 300 may further include a biasing member mount 364 operatively attached to the at least one guide bar 354. Additionally, the biasing member 362 may include a first biasing member projection 366 and a second biasing member projection 368. The first biasing member projection 366 may extend from the biasing member 362 to contact the biasing member mount 364. The second biasing member projection 368 may extend from the biasing member 362 to contact the linkage mounting member 312. Cumulatively, the biasing member may exert a force on the biasing member mount 364 and the linkage mounting member 312 to urge the at least one guide bar 354 such that the footrest deck section 138 is biased toward the stowed position 138S.

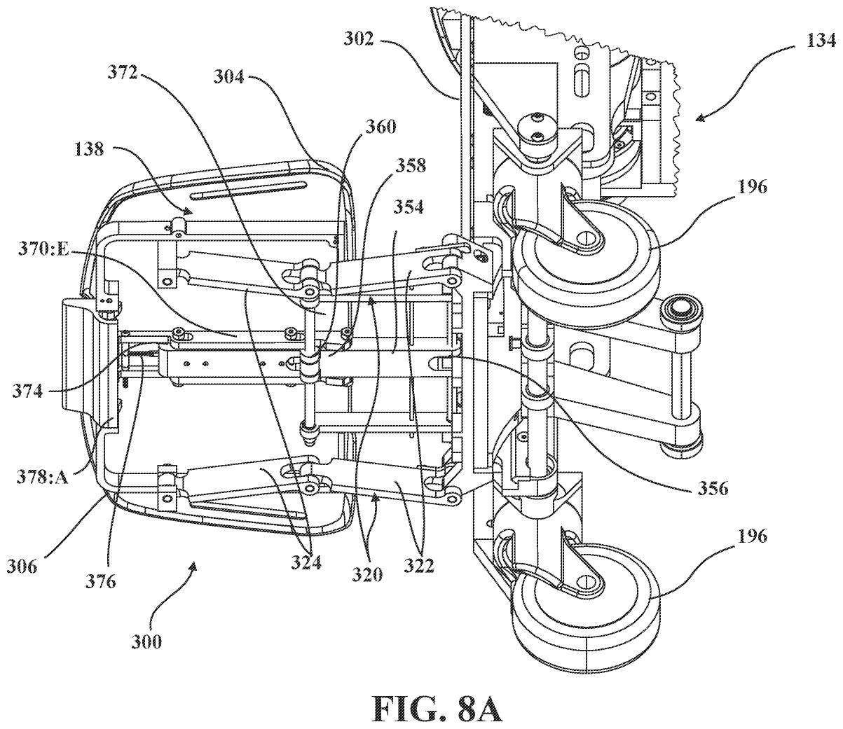

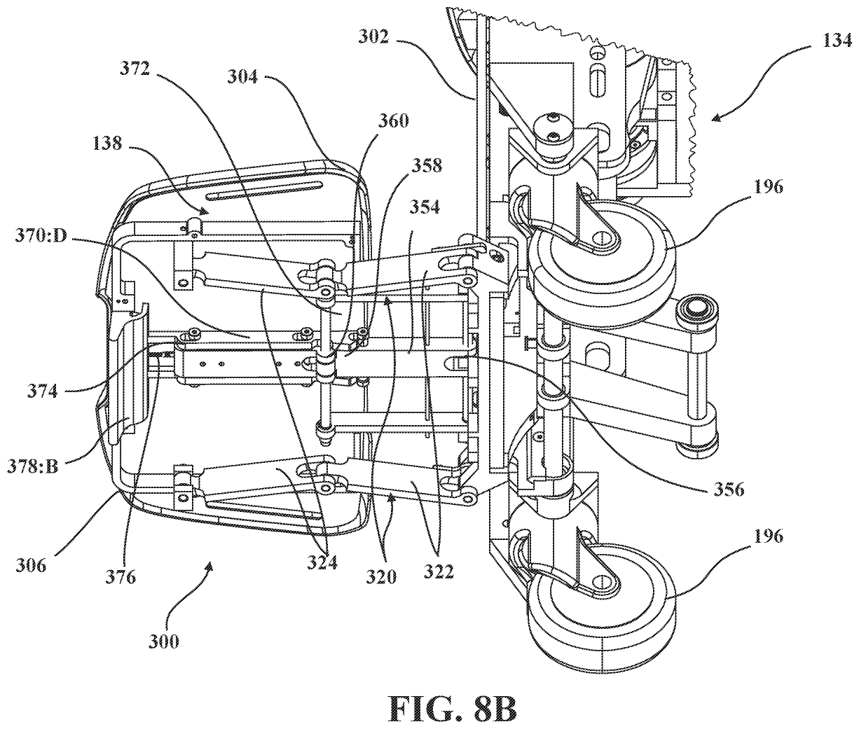

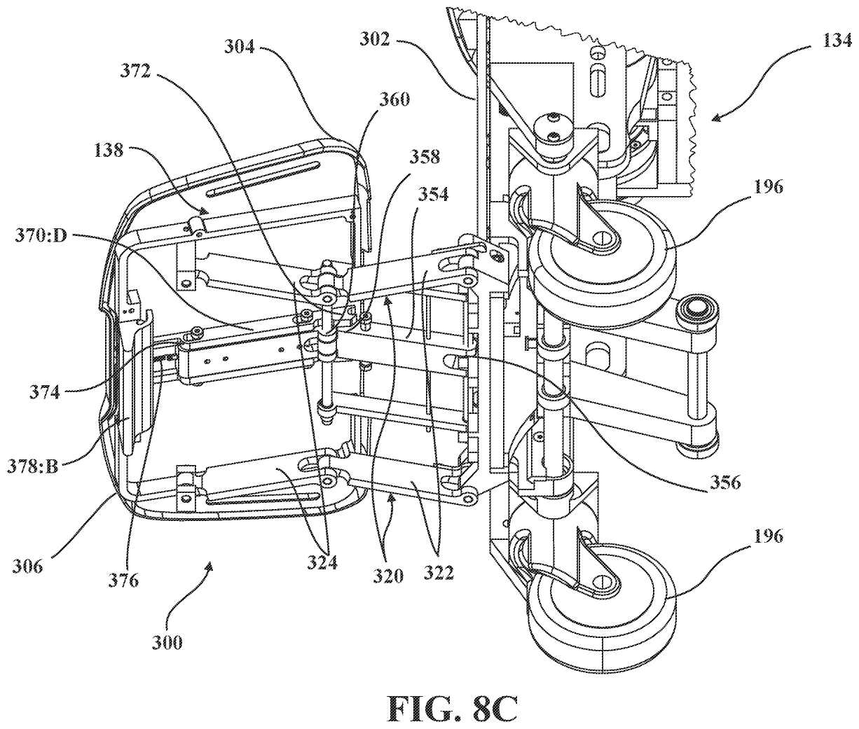

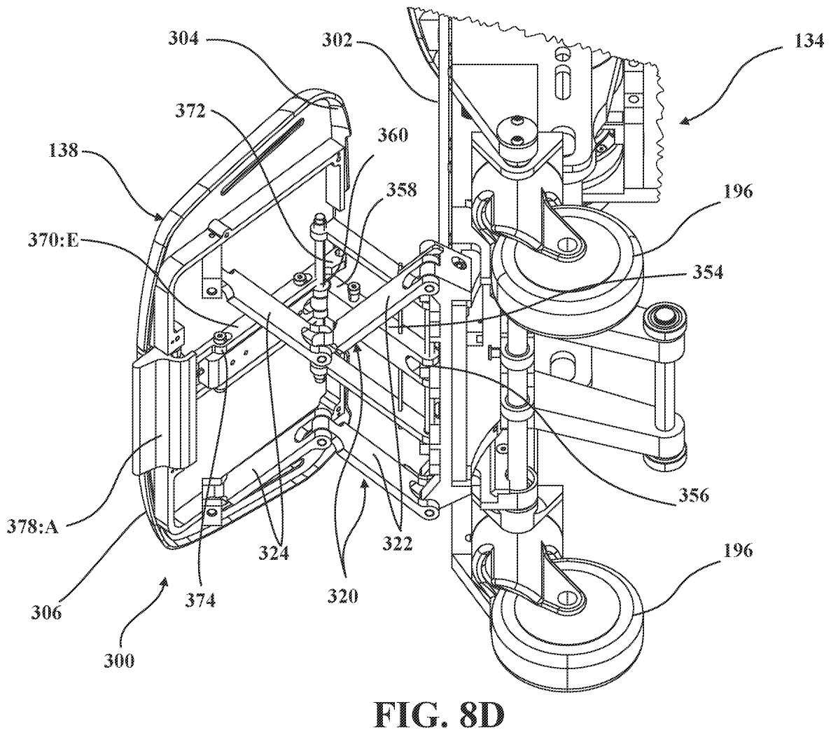

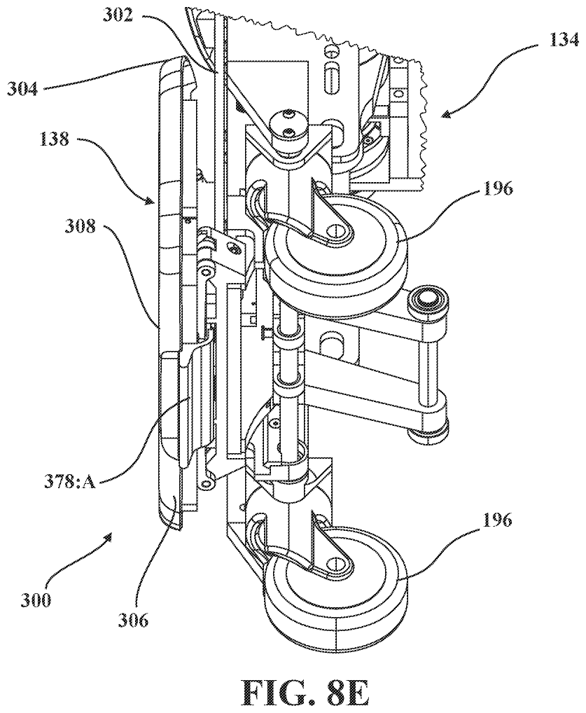

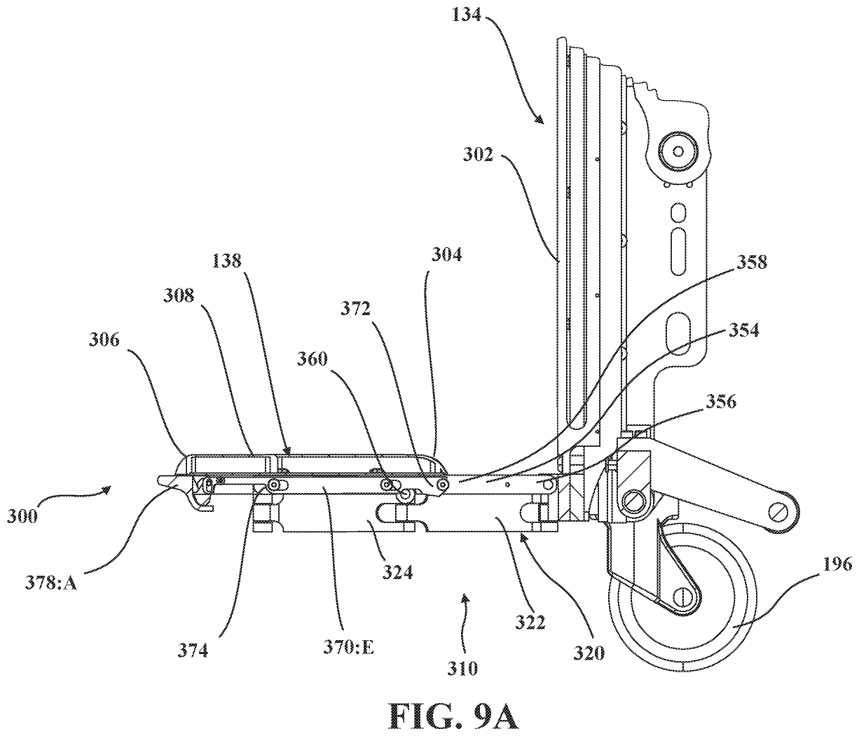

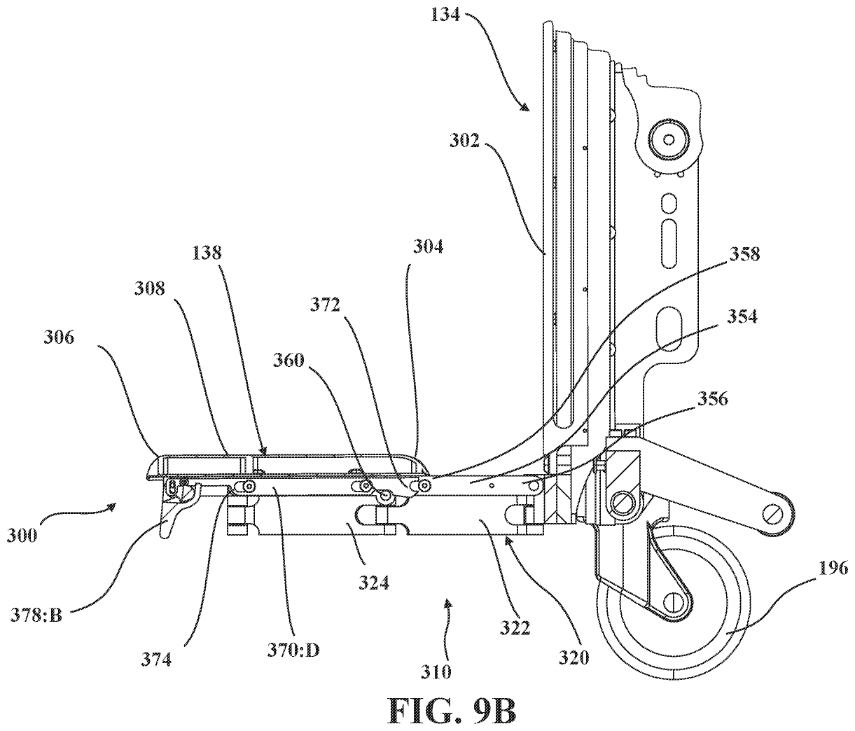

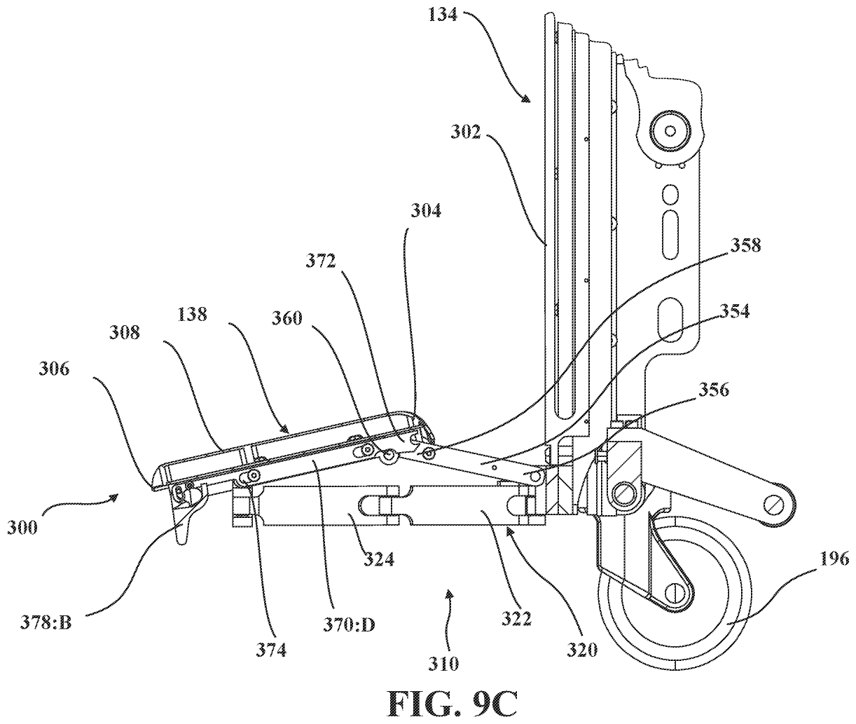

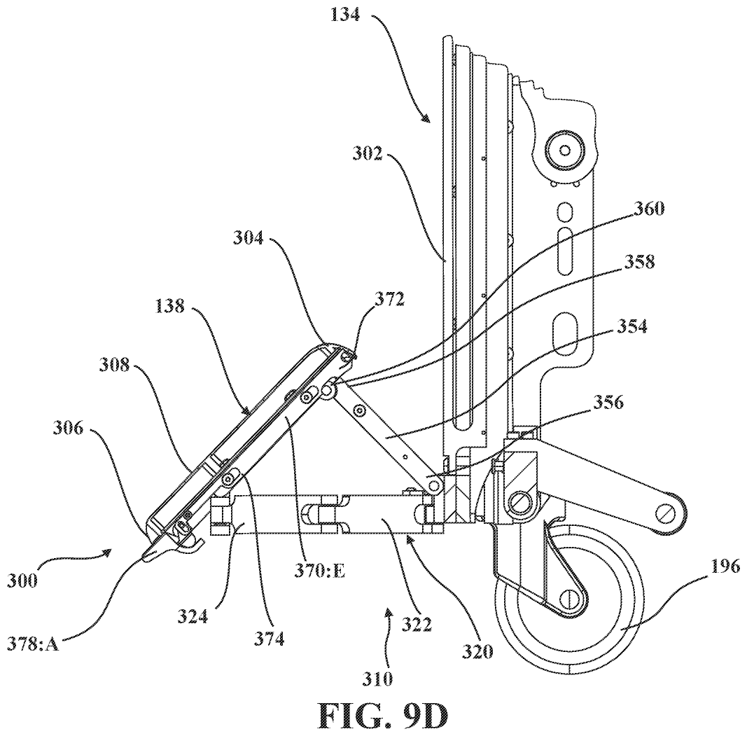

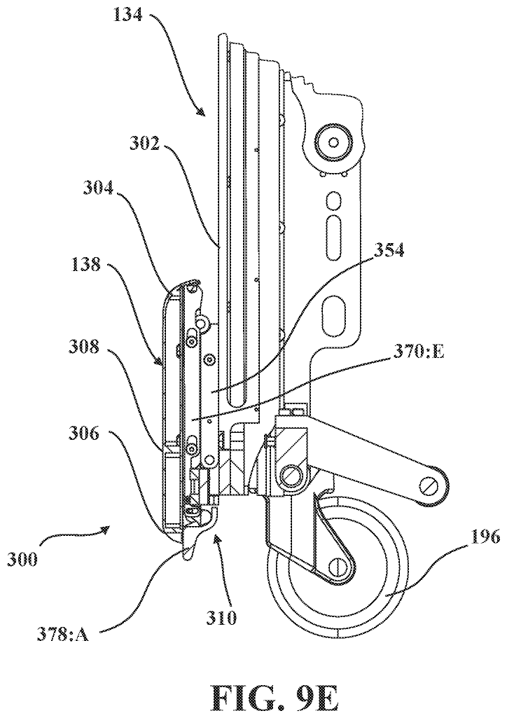

Referring now to FIGS. 8A-9E, the footrest assembly 300 may further include a toggle member 370 for locking the footrest deck section 138 in the deployed position 138D. The toggle member 370 is operatively attached to the footrest deck section 138 and extends between a first end 372 and a second end 374. The toggle member 370 is operable to move between an engaged state 370E and a disengaged state 370D. In the engaged state 370E, the first end 372 of the toggle member 370 engages the at least one guide bar 354 to limit movement of the footrest deck section 138 relative to the front assembly 134. For example, the first end 372 may engage the guide bar pivot end 358 when the footrest deck section 138 is in the deployed position 138D. Accordingly, movement of the footrest deck section 138 relative to the front assembly, such as upward to the stowed position 138S is limited, such as shown in FIGS. 8A and 9A.

Referring now to FIGS. 8B and 9B, when the toggle member 370 is moved to the disengaged state 370D, the first end 372 is spaced from the at least one guide bar 354 to permit movement of the footrest deck section 138 relative to the front assembly 134. Accordingly, referring to FIGS. 8C and 9C, with the first end 372 spaced from the at least one guide bar 354, the first edge 304 of footrest deck section 138 may move upward such that the footrest deck section 138 is no longer in the deployed position 138D and free to articulate to the stowed position 138S.

As noted above, the biasing member 362 may urge the at least one guide bar 354 such that the footrest deck section 138 is biased toward the stowed position 138S. FIGS. 8A-9B illustrate a sequence of the toggle member 370 moving from the engaged state 370E to the disengaged state 370D. Once the toggle member 370 is in the disengaged state, FIGS. 8C-9E illustrate the footrest biasing member moving toward the stowed position 138S as a result of the biasing member 362 urging the at least one guide bar 354 upward.

Referring to FIGS. 8A-9C, the footrest assembly 300 may further include a toggle biasing member 376. The toggle biasing member 376 may be interposed in force translating relation between the footrest deck section 138 and the toggle member 370. Accordingly, the toggle biasing member may be arranged to exert a force on the toggle member 370 to urge the toggle member toward the engaged state 370E. Thus, when the footrest deck section 138 reached the deployed position 138D, the toggle member 370 is urged by the toggle biasing member 376 toward the engaged state 370E to limit movement of the footrest deck section 138 relative to the front assembly 134.

Referring to FIGS. 8A-9E, the footrest assembly 300 may further include a release lever 378 that is operatively attached to the toggle member 370. The release lever 378 may be arranged for selective movement between a first state 378A and a second state 378B. When the release lever is in the first state 378A (best shown in FIGS. 8A and 9A), the toggle member 370 is in the engaged state 370E. However, when the release lever 378 is moved to the second state 378B (best shown in FIGS. 8B and 9B), the release lever 378 moves the toggle member 370 to the disengaged state 370D, thereby allowing the footrest deck section 138 to move from the deployed position 138D toward the stowed position 138S. Again, as discussed above, the biasing member 362 biases the at least one guide bar 354 such that the footrest deck section 138 is biased toward the stowed position 138S. Thus, when the release lever 378 is moved to the second state 378B, the toggle member 370 is disengaged from the at least one guide bar 354 and the biasing member 362 urges the footrest deck section 138 upward toward the stowed position 138S in response to the release lever 378 being moved to the second state 378B. Accordingly, the footrest deck section 138 is automatically retracted from the deployed position 138D to the stowed position 138S in response to the release lever 378 being moved from the first state 378A to the second state 378B.

It will be further appreciated that the terms “include,” “includes,” and “including” have the same meaning as the terms “comprise,” “comprises,” and “comprising.” Moreover, it will be appreciated that terms such as “first,” “second,” “third,” and the like are used herein to differentiate certain structural features and components for the non-limiting, illustrative purposes of clarity and consistency.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient support apparatus comprising:
a front assembly having a front portion and a bottom end including a wheel for contacting a ground surface; and
a footrest assembly operatively attached to the front assembly, the footrest assembly comprising:
   a footrest deck section extending between a first edge and a second edge, and
   a linkage assembly operatively attached to and extending between the front portion of the front assembly and the footrest deck section to guide movement of the footrest deck section relative to the front assembly between:
      a stowed position where the footrest deck section is substantially parallel to the front portion of the front assembly and the first edge is arranged further than the second edge from the wheel, and
      a deployed position where the footrest deck section is substantially perpendicular to the front portion of the front assembly and the first edge is arranged closer than the second edge to the wheel.
II. A patient support apparatus comprising:
a front assembly having a front portion and a wheel for contacting a ground surface; and
a footrest assembly operatively attached to the front assembly, the footrest assembly comprising:
   a footrest deck section having a front surface, and
   a linkage assembly operatively attached to and extending between the front portion of the front assembly and the footrest assembly to guide movement of the footrest assembly relative to the front assembly between:
      a stowed position where the front surface of the footrest deck section is substantially parallel with and faces away from the front portion of the front assembly, and
      a deployed position where the front surface is substantially perpendicular to the front portion of the front assembly and arranged such that the front surface faces away from the ground surface.
III. A patient support apparatus comprising:
a front assembly having a front portion; and
a footrest assembly operatively attached to the front assembly, the footrest assembly comprising:
   a footrest deck section extending between a first edge and a second edge, and
   a linkage assembly operatively attached to and extending between the front portion of the front assembly and the footrest assembly to guide movement of the footrest assembly relative to the front assembly between:
      a stowed position where the footrest deck section is substantially parallel to the front portion of the front assembly, and
      a deployed position where the footrest deck section is substantially perpendicular to the front portion of the front assembly,
      wherein the second edge of the footrest deck section follows a linear translation path defined by movement of the footrest deck section between the stowed position and the deployed position.
IV. The patient support apparatus of any of clauses I-III, wherein the linkage assembly includes a six-bar linkage.
V. The patient support apparatus of any of clauses I-IV, wherein the footrest assembly further comprises a linkage mounting member configured to be operatively attached to the front assembly, wherein the linkage assembly is operatively attached to and extends between the footrest deck section and the linkage mounting member.
VI. The patient support apparatus of clause V, wherein the linkage mounting member further comprises a pair of vertical pivot mounts each extending from the linkage mounting member and each defining a respective vertical mount pivot axis.
VII. The patient support apparatus of clause VI, wherein the pair of vertical pivot mounts are each configured to receive respective vertical pivot dowels defining a respective one of the vertical mount pivot axes.
VIII. The patient support apparatus of any of clauses V-VI, wherein the linkage assembly further comprises a pair of hinge subassemblies each respectively including:
a first member extending between:
   a first hinge end, and
   a first mounting end coupled to a respective one of the pair of vertical pivot mounts for pivoting movement about the vertical mount pivot axis; and
a second member extending between:
   a second hinge end coupled to the first hinge end for pivoting movement relative to the first member about a hinge pivot axis, and
   a second mounting end operatively attached to the footrest deck section;
wherein the hinge pivot axis is parallel to the vertical mount pivot axis.
IX. The patient support apparatus of clause VIII, wherein concurrent movement of the pair of hinge subassemblies guide the footrest deck section along a linear translation path as the footrest deck section moves between the stowed position and the deployed position.
X. The patient support apparatus of any of clauses VIII-IX, wherein the first hinge end and the second hinge end are coupled by a hinge pivot dowel that defines the hinge pivot axis.
XI. The patient support apparatus of any of clauses VIII-X, wherein the linkage assembly further comprises:
a pair of footrest mounting members coupled to the footrest deck section for pivoting movement about a footrest mounting axis disposed in non-parallel spaced relation to the vertical mount pivot axes.
XII. The patient support apparatus of clause XI, wherein the footrest mounting axis is arranged orthogonal to the vertical mount pivot axes.
XIII. The patient support apparatus of any of clauses XI-XII, wherein the pair of footrest mounting members each define a hinge mounting member coupled to the second hinge end for pivoting movement about a respective hinge mounting axis.
XIV. The patient support apparatus of clause XIII, wherein the hinge mounting are arranged parallel to the vertical mount pivot axes.
XV. The patient support apparatus of any of clauses XIII-XIII, wherein the hinge mounting members each include a hinge mount dowel defining the respective hinge mounting axes.
XVI. The patient support apparatus of clause XV, wherein each respective second hinge end is coupled to a respective one of the hinge mount dowels for pivoting movement about one of the hinge mounting axes.
XVII. The patient support apparatus of any of clauses V-XVI, wherein the linkage mounting member further comprises a horizontal pivot mount extending from the linkage mounting member.
XVIII. The patient support apparatus of clause XVII, wherein the linkage assembly further comprises at least one guide bar extending between:
a guide bar mounting end coupled to the horizontal pivot mount for pivoting movement relative to the horizontal pivot mount, and
a guide bar pivot end coupled to a guide bar pivot mount of the footrest deck section for pivoting movement relative to the guide bar pivot mount to guide motion of the footrest deck section as the footrest deck section moves between the stowed position and the deployed position.
XIX. The patient support apparatus of clause XVIII, wherein the footrest assembly further comprises a biasing member arranged to urge the guide bar such that the footrest deck section is biased toward the stowed position.
XX. The patient support apparatus of clause XIX, wherein the biasing member is disposed about the horizontal pivot mount.
XXI. The patient support apparatus of any of clauses XIX-XX, wherein:
the footrest assembly further comprises a biasing member mount operatively attached to the at least one guide bar, and
the biasing member includes a first biasing member projection arranged to contact the biasing member mount and a second biasing member projection arranged to contact the linkage mounting member.
XXII. The patient support apparatus of any of clauses XVIII-XXI, wherein the footrest assembly further comprises a toggle member extending between: a first end, and a second end and operatively attached to the footrest deck section, with the toggle member being operable between:
an engaged state where the first end of the toggle member engages the guide bar to limit movement of the footrest deck section relative to the front assembly, and
a disengaged state where the first end of the toggle member is spaced from the guide bar to permit movement of the footrest deck section relative to the front assembly.
XXIII. The patient support apparatus of clause XXII, wherein the footrest assembly further comprises a toggle biasing member interposed in force translating relation between the footrest deck section and the toggle member to urge the toggle member toward the engaged state.
XXIV. The patient support apparatus of clause XXIII, wherein the footrest assembly further comprises a release lever operatively attached to the toggle member and arranged for selective movement between:
a first state where the toggle member is in the engaged state, and
a second state where the release lever moves the toggle member to the disengaged state to enable movement of the footrest deck section relative to the front assembly.
XXV. The patient support apparatus of clause XXIV, wherein the footrest assembly further comprises a footrest biasing member arranged to urge the guide bar such that the footrest deck section is biased toward the stowed position.
XXVI. The patient support apparatus of clause XXV, wherein the footrest biasing member is disposed about the horizontal pivot mount.
XXVII. The patient support apparatus of any of clauses XXV-XXVI, wherein the footrest biasing member urges the footrest deck section toward the stowed position in response to movement of the release lever to the second state to automatically retract the footrest deck section to the stowed position.
XXVIII. The patient support apparatus of any of clauses I-III, wherein the footrest deck section is spaced from the front assembly in the deployed position at distance defined by a ratio of at least 0.33 of a height of the footrest deck section.

1. A patient support apparatus comprising:
a front assembly having a front portion and a bottom end including a wheel for contacting a ground surface; and
a footrest assembly operatively attached to the front assembly, the footrest assembly comprising:
a footrest deck section extending between a first edge and a second edge, and
a linkage assembly operatively attached to and extending between the front portion of the front assembly and the footrest deck section to guide movement of the footrest deck section relative to the front assembly between:
a stowed position where the footrest deck section is substantially parallel to the front portion of the front assembly and the first edge is arranged further than the second edge from the wheel, and
a deployed position where the footrest deck section is substantially perpendicular to the front portion of the front assembly and the first edge is arranged closer than the second edge to the wheel.

2. The patient support apparatus of claim 1, wherein the linkage assembly includes a six-bar linkage.

3. The patient support apparatus of claim 1, wherein the footrest assembly further comprises a linkage mounting member configured to be operatively attached to the front assembly, wherein the linkage assembly is operatively attached to and extends between the footrest deck section and the linkage mounting member.

4. The patient support apparatus of claim 3, wherein the linkage mounting member further comprises a pair of vertical pivot mounts each extending from the linkage mounting member and each defining a respective vertical mount pivot axis.

5. The patient support apparatus of claim 4, wherein the pair of vertical pivot mounts are each configured to receive respective vertical pivot dowels defining a respective one of the vertical mount pivot axes.

6. The patient support apparatus of claim 4, wherein the linkage assembly further comprises a pair of hinge subassemblies each respectively including:
a first member extending between:
a first hinge end, and
a first mounting end coupled to a respective one of the pair of vertical pivot mounts for pivoting movement about the vertical mount pivot axis; and
a second member extending between:
a second hinge end coupled to the first hinge end for pivoting movement relative to the first member about a hinge pivot axis, and
a second mounting end operatively attached to the footrest deck section;
wherein the hinge pivot axis is parallel to the vertical mount pivot axis.

7. The patient support apparatus of claim 6, wherein concurrent movement of the pair of hinge subassemblies guide the footrest deck section along a linear translation path as the footrest deck section moves between the stowed position and the deployed position.

8. The patient support apparatus of claim 6, wherein the first hinge end and the second hinge end are coupled by a hinge pivot dowel that defines the hinge pivot axis.

9. The patient support apparatus of claim 6, wherein the linkage assembly further comprises:
a pair of footrest mounting members coupled to the footrest deck section for pivoting movement about a footrest mounting axis disposed in non-parallel spaced relation to the vertical mount pivot axes.

10. The patient support apparatus of claim 9, wherein the footrest mounting axis is arranged orthogonal to the vertical mount pivot axes.

11. The patient support apparatus of claim 9, wherein the pair of footrest mounting members each define a hinge mounting member coupled to the second hinge end for pivoting movement about a respective hinge mounting axis.

12. The patient support apparatus of claim 11, wherein the hinge mounting are arranged parallel to the vertical mount pivot axes.

13. (canceled)

14. (canceled)

15. The patient support apparatus of claim 3, wherein the linkage mounting member further comprises a horizontal pivot mount extending from the linkage mounting member.

16. The patient support apparatus of claim 15, wherein the linkage assembly further comprises at least one guide bar extending between:
a guide bar mounting end coupled to the horizontal pivot mount for pivoting movement relative to the horizontal pivot mount, and
a guide bar pivot end coupled to a guide bar pivot mount of the footrest deck section for pivoting movement relative to the guide bar pivot mount to guide motion of the footrest deck section as the footrest deck section moves between the stowed position and the deployed position.

17. The patient support apparatus of claim 16, wherein the footrest assembly further comprises a biasing member arranged to urge the guide bar such that the footrest deck section is biased toward the stowed position.

18. (canceled)

19. The patient support apparatus of claim 17, wherein:
the footrest assembly further comprises a biasing member mount operatively attached to the at least one guide bar, and
the biasing member includes a first biasing member projection arranged to contact the biasing member mount and a second biasing member projection arranged to contact the linkage mounting member.

20. The patient support apparatus of claim 16, wherein the footrest assembly further comprises a toggle member extending between: a first end, and a second end and operatively attached to the footrest deck section, with the toggle member being operable between:
an engaged state where the first end of the toggle member engages the guide bar to limit movement of the footrest deck section relative to the front assembly, and
a disengaged state where the first end of the toggle member is spaced from the guide bar to permit movement of the footrest deck section relative to the front assembly.

21. The patient support apparatus of claim 20, wherein the footrest assembly further comprises a toggle biasing member interposed in force translating relation between the footrest deck section and the toggle member to urge the toggle member toward the engaged state.

22. The patient support apparatus of claim 21, wherein the footrest assembly further comprises a release lever operatively attached to the toggle member and arranged for selective movement between:
a first state where the toggle member is in the engaged state, and
a second state where the release lever moves the toggle member to the disengaged state to enable movement of the footrest deck section relative to the front assembly.

23. The patient support apparatus of claim 22, wherein the footrest assembly further comprises a footrest biasing member arranged to urge the guide bar such that the footrest deck section is biased toward the stowed position; and
wherein the footrest biasing member urges the footrest deck section toward the stowed position in response to movement of the release lever to the second state to automatically retract the footrest deck section to the stowed position.

24. (canceled)

25. (canceled)

26. (canceled)

27. (canceled)

28. (canceled)
